(19) United States
(12) Patent Application Publication
(10) Pub. No.: US 2014/0270886 A1
(43) Pub. Date: Sep. 18, 2014

(54) WRITING IMPLEMENT HOLDER

(71) Applicant: Angelo P. Verdelli, Jr., South Portland, ME (US)

(72) Inventor: Angelo P. Verdelli, Jr., South Portland, ME (US)

(21) Appl. No.: 13/832,337

(22) Filed: Mar. 15, 2013

(51) Int. Cl. B43K 23/004

(52) U.S. Cl. CPC B43K 23/004
USPC 401/6

(57) ABSTRACT

A writing implement holder comprises an elongated hollow housing. An electric motor is fixed at one end of the housing and having an output shaft thereof aligned with a longitudinal axis of the housing. A source of electric power is coupled to the motor. A gripping member is mounted within a hollow interior of the housing and has one end thereof securely attached to the output shaft of the motor. The gripping member is configured to receive one end of the writing implement for rotation with the output shaft of the motor, when the writing implement is inserted though an axially opposite open end of the housing. Manually operable ON/OFF switch is also provided.

### FIELD OF THE INVENTION

The present invention relates, in general, to writing implements and, more particularly, this invention relates to an electrically operated writing implement that is configured to reduce pressure required to be exerted onto a surface during writing and/or coloring activity and yet more particularly, the instant invention relates to an electrically operated writing implement that aids children and adults having fine motor skill difficulties.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

As is generally well known, writing and/or coloring activity requires pressure to be applied by a writing implement onto the writing or coloring surface. Generally, such pressure is applied by a hand of the user of such writing implements. However, application of such pressure may be challenging to young children who have not developed fine motor skills or to adults who have diminished fine motor skills due to injury, disease and/or age.

Prior to the conception and design of the instant invention efforts have been made to alleviate problems experienced by those with insufficient fine motor skills during writing and/or coloring effort.

For example, U.S. Pat. No. 8,348,534 issued on Jan. 8, 2013 to Brindise discloses a generally tubular gripping member that has an essentially cylindrical exterior surface and a bore forming a cylindrical interior surface. The gripping member has a leading and a trailing face. The writing implement is frictionally received by and supported within the interior surface of the gripping member. The leading end of the writing implement is spaced from the leading face of the gripping member. The gripping member is fabricated of a resilient material.

U.S. Pat. No. 6,213,961 issued on Apr. 10, 2001 to Reinsma teaches a holder for a wiring implement, such as a ball-point cartridge, eating implements, such as a fork, a knife or like implement. The holder is arranged for holding the implement (12) and comprises means (5, 6, 8, 9) for vibrating the housing (1) with a frequency in the order of 50 to 100 Hz and an amplitude of the force causing the vibration in the order of 0.3 to 2.5 Newton. Preferably, the frequency and amplitude are adjustable. The vibrating holder enables greatly improved motor control of the implement in question for many patients.

However, it has been found that additional improvements are required to aid children and adults having fine motor skill difficulties.

### SUMMARY OF THE INVENTION

The invention provides an electrically operated writing implement holder. The holder includes an elongated hollow housing. An electric motor is fixed at one end of the housing and has an output shaft thereof aligned with a longitudinal axis of the housing. A source of electric power is coupled to the motor. A gripping member is mounted within a hollow interior of the housing and has one end thereof securely attached to the output shaft of the motor. The gripping member is configured to receive one end of the writing implement for rotation with the output shaft of the motor when the writing implement is inserted though an axially opposite open end of the housing. The invention also provides a manually operated switch to supply and discontinue supply of electric power to the motor and optional means for restraining radial movement of the writing implement at an end of the housing being axially opposite the end having the motor attached thereto. In another embodiment, the housing is provided adjustable in length by way of two telescopic or threaded sections.

### OBJECTS OF THE INVENTION

It is, therefore, one of the primary objects of the present invention to provide an electrically operated writing implement holder that aids children and adults having fine motor skill difficulties.

Another object of the present invention is to provide an electrically operated writing implement holder that reduces pressure required to be exerted onto a surface during writing and/or coloring activity.

Yet another object of the present invention is to provide an electrically operated writing implement holder that is configured for writing implements of various cross-sectional sizes.

A further object of the present invention is to provide an electrically operated writing implement holder that is configured for writing implements of various lengths.

Yet a further object of the present invention is to provide an electrically operated writing implement holder that includes a linearly adjustable housing.

An additional object of the present invention is to provide an electrically operated writing implement holder that includes an internally disposed gripping member.

Another object of the present invention is to provide an electrically operated writing implement holder that includes means to at least restrict radial movement of the writing implement during rotation thereof.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a cross-sectional elevation view of an electrically operated writing implement holder of the instant invention;

FIG. 2 is a partial cross-sectional elevation view of an electrically operated writing implement holder of FIG. 1, particularly illustrating a gripping member constructed in accordance with alternative embodiment; and

FIG. 3 is a partial cross-sectional elevation view of an electrically operated writing implement holder of FIG. 1, particularly illustrating an alternative embodiment of an optional means for retraining radial movement of a writing implement;

FIG. 4 is cross-sectional view of the electrically operated writing implement holder along lines IV-IV of FIG. 3;

FIG. 5 is a partial cross-sectional elevation view of an electrically operated writing implement holder of FIG. 1, particularly illustrating an adjustable length housing of one form; and

FIG. 6 is a partial cross-sectional elevation view of an electrically operated writing implement holder of FIG. 1, particularly illustrating an adjustable length housing of another form.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

Now in reference to FIGS. 1-4, therein is illustrated an electrically operated writing implement holder, generally designated as 10 configured to hold and rotate writing implement 2. The writing implement 2 can be, without limitations, a marker, pencil, pen, crayon and the like writing implements.

The holder 10 includes an elongated hollow housing 20 having a hollow interior 22. An inner surface 26 and an outer surface 28 are spaced from each other to define a generally uniform thickness of the wall 24. The elongated hollow housing 20 also defines a longitudinal axis 12 of the holder 10. Preferably, the elongated hollow housing 20 has a ring shaped cross-section in a plane normal to the longitudinal axis 12.

One end of the housing is closed, for example by an end member 30 having a threaded arrangement 32 with the housing 20. Advantageously, the member 30 also is adapted with an electrical contact 34 and may be further adapted with a bias spring (not shown). The axially opposite end of the housing 20 may be open but is preferably closed with the member 36 having an axial aperture 38 formed through a thickness thereof. Aperture 38 would be sized to accommodate either a specific type of writing implement 2 or sized to accommodate writing implements 2 of various cross-sectional sizes.

An electric motor 40 is fixed at one end of the housing 20 and has an output shaft 42 thereof aligned with the longitudinal axis 12. A source 44 of electric power is coupled to the motor 40. The invention contemplates that the motor 40 and the power source 44 are mounted in any of the conventional ways of mounting such devices in other applications, for example such as toothbrush. It is also contemplated that the member 30 may be replaced with a section of the housing 20 adapted with an elongated cover (not shown) in a snap type and/or fastened arrangements to selectively expose or cover motor 40 and power source 44.

Although the electrical circuit could be so constructed and the power source 44 could be so mounted that motor 40 is energized when the holder 10 is in a generally upright position with the writing implement 2 facing downwardly and the power source 44 is in contact with the motor 40. However, it is presently preferred to provide a manually operable switch 46 having contacts thereof coupled in a circuit mediate the electric motor 40 and the power source 44 and operable to selectively supply electric power to the motor 40 and discontinue supply of the electric power. Conventionally, the switch 46 may be of a pushbutton type adapted with the spring 48 or may be of a sliding type. Both the electric motor 40 and the power source 44 are shown in FIG. 1 absent of internal structure, which is conventional in the art. For example, the motor 40 may be of the type as used in battery operated toothbrushes and power source 40 may be any conventional battery of a disposable or rechargeable type.

Yet alternatively, touch switch, for example of a capacitance type (not shown) with appropriate electrical circuitry (not shown) may be provided to energize the motor 40 when the user grabs the outer surface 28 of the housing 20. Such touch switch may be of the type presently employed on selected kitchen and/or bathroom water faucets.

Furthermore, the switch 46 can be configured in a sliding rheostat type to provide adjustable rotational speed of the output shaft 42.

A gripping means or member 50 is mounted within the hollow interior 22 of the housing 20 and has one end 52 thereof securely attached to the output shaft 42 of the motor 40. The gripping member 50 is configured to receive one end of the writing implement 2 for rotation with the output shaft 42 of the motor 40, when the writing implement 2 is inserted though an axially opposite generally open end of the housing 20.

The gripping member 50 is configured to accommodate writing implements 2 of different cross-sectional shapes and/or sizes. By way of one example only, the gripping member 50 is defined by plurality of elongated members 54 having proximal end affixed to the output shaft 32 and extending at an incline from the output shaft 32 toward an inner surface 24 of the housing 20, wherein distal ends 56 of the plurality of elongated members 54 are adapted for movement in a radial direction relative to a longitudinal axis 12 of the writing implement holder 10, as is best shown by arrows A. The plurality of gripping members 54 may include a plurality of teeth 58 positioned to engage an exterior surface 4 of the writing implement 2 or may include elastomeric members 59 attached thereto, the elastomeric members 59 positioned to engage the exterior surface 4 of the writing implement 2.

The writing implement holder 10 may further include another or second hollow housing 70 disposed within a hollow interior 22 of the housing 20 and wherein the gripping member 50 is generally positioned within a hollow interior 72 of the another or second housing 70. The function of the another or second housing 70 is to restrict radial expansion of the gripping member 50, wherein the distal ends 56 of the plurality of elongated members 54 are allowed to touch inner surface 74 of the another or second housing 70.

In accordance with another form of the invention, best shown in FIG. 2, the writing implement holder 10 includes the gripping member 80 defining another or second housing 82 having one end thereof attached to the output shaft 32, a conical or frustoconical inner bore 84 and a thread 86 formed on a surface of the conical or frustoconical inner bore 84. The thread 86 is so configured as to engage the exterior surface 4 of the writing implement 2. The exterior surface 88 of the second housing 82 may be separated by a peripheral gap from the inner surface 26 of the hollow housing 20 or be in abutting contact therewith, as is best shown in FIG. 5 below. Furthermore, thread 86 may be any other suitable arrangement, for example such as teeth or elastomeric member, suitable to grip the end of the writing implement 2 in a manner preventing substantial independent rotation thereof relative to the rotation of the output shaft 42, although a small independent rotation is allowed due to manufacturing tolerances, variations of the writing implements 2, etc.

The writing implement holder 10 may include an optional means, generally designated as 90, for at least restricting radial movement of the writing implement 2 during rotation thereof. By way of one example only, such means 90 may include the axial aperture 38. By way of another example, the means 90 is configured to include one or more members or fingers 92 secured to an inner surface 24 of the housing 20 and being configured to at least partially collapse and return to the original position in a resilient manner, as illustrated by arrows B, so as to receive the writing implement 2 therethrough. Such members or fingers 92 may be provided in a unitary type construction having a common proximal end 94 being affixed to the inner surface 24 of the housing 20. The distal end 96 of members or fingers 92 may be configured to curve away from the longitudinal axis 12 and the exterior surface 4 of the writing implement 2 so as to ease insertion of the writing implement 2 and guide the writing implement 2 into a position aligned with the longitudinal axis 12 and further guide the insertion of the writing implement 2 into the gripping member 50. As is also seen in FIG. 1, members or fingers 92 may be generally inclined to the longitudinal axis 12 in a plane generally parallel thereto.

The members or fingers 92 are manufactured from spring steel material, elastomeric material and any combination thereof. For example, the proximal end 94 may be of a rigid construction afforded by conventional metals and/or engineered plastics.

By way of another example of FIGS. 3-4, such means 90 may comprise one or more members 100 disposed in a plane being generally normal to the longitudinal axis 12 and having an outer edge and/or surface 102 thereof affixed to the interior surface 22 of the housing 20. The inner edge and/or surface 104 defines an axial aperture 106 and a plurality of teeth or fingers 108 disposed in a spaced apart relationship with each other along the edge and/or surface 104 and that are configured to resiliently flex in a direction along the longitudinal axis 12 when the writing implement 2 is inserted through the aperture 106. It is further contemplated that, the plurality of teeth or fingers 108 do not have to touch the exterior surface 4 but be configured so as to restrain the excessive radial movement of the writing implement 2 and, particularly the tip 6, during rotation thereof.

In accordance with another form of the invention of FIGS. 5-6, the holder 10 includes hollow housing, generally designated as 120, that is configured to adjust to different length and, therefore, includes means for adjusting a length of the housing 120. Exemplarily, the housing 120 is configured to include a first portion 122 having the motor 30 attached thereto and a second portion 124 configured for a longitudinal reciprocal movement relative to the first portion 124. More specifically, the first and second portions, 122 and 124 respectively, are provided as a pair of telescopic portions, wherein the second portion 124 includes one or more indentations 128 defined on an exterior surface 126 thereof along a length of the second portion 124 and wherein the writing implement holder 10 includes a clip 140 having one end 142 thereof fixed to an exterior surface 130 of the first portion 122 and having an opposite end 144 thereof configured for engagement with a selective one from the one or more indentations 128.

Alternatively, the first and second portions, 122 and 124 respectively, may be adapted with complimentary threaded arrangement 150.

The adjustable housing 120 is advantageous not only to accommodate writing implements 2 of different lengths but also to control extension of the writing implement 2 past the free end of the second portion 124 in order to restrict the radial movement of such extending end of the writing implement 2. The remaining features of the holder 10, described in combination with housing 20, apply to the holder 100 and their description is omitted herein for the sake of brevity.

The invention contemplates that the end member 36 may be configured to incorporate the above described teeth or fingers 108 as part of the end member 36 and even adapt the end member 36 with curved end portions 96.

In operation, the writing implement 2 is inserted into the housing 20, 120 until it is securely gripped by the gripping member 50 so that the writing implement 2 rotates with the output shaft 42.

If the invention is to be used by small child, than a parent or a guardian can insert the writing implement 2 and energize the motor by way of a switch, such as above described switch 46. When the writing implement 2 rotates, the small child has to only bring the tip of the writing implement 2 in contact with the paper or other working surface without the need to apply pressure. When the tip 6 is in close proximity to the end of the housing 20, 120, the writing implement 2 is replaced, in view of housing 20, or the length of the housing 120 is adjusted to uncover previously hidden length portion of the writing implement 2. The invention is advantageous for both coloring and writing activities.

It will be understood that the same benefits will be realized by an adult whose fine motor skills diminished due to injury, disease and/or age.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A writing implement holder comprising:
(a) an elongated hollow housing;
(b) an electric motor fixed at one end of said housing and having an output shaft thereof aligned with a longitudinal axis of said housing;
(c) a source of electric power coupled to said motor; and
(d) a gripping member mounted within a hollow interior of said housing and having one end thereof securely attached to said output shaft of said motor, said gripping member configured to receive one end of the writing implement for rotation with said output shaft of said motor, when said the writing implement is inserted though an axially opposite open end of said housing.

2. The writing implement holder of claim 1, further including another hollow housing disposed within said hollow interior of said housing and wherein said gripping member is generally positioned within a hollow interior of said another housing.

3. The writing implement holder according to claim 2, wherein said gripping member is configured to accommodate writing implements of different cross-sectional shapes and/or sizes.

4. The writing implement holder according to claim 3, wherein said gripping member is defined by plurality of elongated members having a proximal end thereof secured to said output shaft and extending at an incline from said output shaft toward an end of said another housing, wherein distal ends of said plurality of elongated members are adapted for movement in a radial direction relative to a longitudinal axis of said writing implement holder.

5. The writing implement holder according to claim 4, wherein each of said plurality of gripping members includes a plurality of teeth positioned to engage an exterior surface of the writing implement.

6. The writing implement holder according to claim 4, wherein each of said plurality of gripping members includes an elastomeric member attached thereto, said elastomeric member positioned to engage an exterior surface of the writing implement.

7. The writing implement holder according to claim 1, wherein said gripping member includes another housing having one end thereof attached to said output shaft, a conical or frustoconical inner bore and a thread or teeth formed on a surface of said conical or frustoconical inner bore said thread or said teeth configured to engage an exterior surface of the writing implement.

8. The writing implement holder of claim 1, further including means for at least restricting radial movement of the writing implement during rotation thereof.

9. The writing implement holder according to claim 8, wherein said means includes one or more members secured to an inner surface of said housing and being configured to at least partially collapse in a resilient manner to receive the writing implement therethrough.

10. The writing implement holder according to claim 8, wherein said means includes a member secured to an inner surface of said housing and having resilient fingers inclined at an angle relative to said longitudinal axis.

11. The writing implement holder according to claim 10, wherein each finger includes a curved end configured to guide the writing implement into a position aligned with said longitudinal axis.

12. The writing implement holder according to claim 10, wherein each said member is manufactured from spring steel material.

13. The writing implement holder according to claim 1, wherein said housing is configured to adjust to different length.

14. The writing implement holder according to claim 13, wherein said housing includes means for adjusting length of said housing.

15. The writing implement holder according to claim 14, wherein said housing includes a first portion having said motor attached thereto and a second portion configured for a longitudinal reciprocal movement relative to said first portion.

16. The writing implement holder according to claim 15, wherein said first and second portions are provided as a pair of telescopic portions, wherein said second portion includes one or more indentations defined on an exterior surface of said second portion along a length thereof and wherein said writing implement holder includes a clip having one end thereof fixed to an exterior surface of said first portion and having an opposite end thereof configured for engagement with a selective one from said one or more indentations.

17. The writing implement holder according to claim 15, wherein said first and second portions are adapted with complimentary threads.

18. The writing implement holder of claim 1, further comprising a manually operable switch having contacts thereof coupled in a circuit mediate said electric motor and said power source and operable to selectively supply and discontinue supply of electric power to said motor.

19. A writing implement holder comprising:
(a) an elongated hollow housing;
(b) an electric motor fixed at one end of said housing and having an output shaft thereof aligned with a longitudinal axis of said housing;
(c) a source of electric power coupled to said motor; and
(d) a gripping member mounted within a hollow interior of said housing and having one end thereof securely attached to said output shaft of said motor, said gripping member a conical or frustoconical inner bore and a thread or teeth formed on a surface of said conical or frustoconical inner bore said thread or said teeth configured to engage an exterior surface of the writing implement.

20. A writing implement holder comprising:
(a) an elongated hollow housing;
(b) an electric motor fixed at one end of said housing and having an output shaft thereof aligned with a longitudinal axis of said housing;
(c) a source of electric power coupled to said motor;
(d) a gripping member mounted within a hollow interior of said housing and having one end thereof securely attached to said output shaft of said motor, said gripping member configured to receive one end of the writing implement for rotation with said output shaft of said motor, when said the writing implement is inserted though an axially opposite open end of said housing; and
(e) means for at least restricting radial movement of a tip of the writing implement during rotation thereof.
